(19) United States
(12) Patent Application Publication
(10) Pub. No.: US 2025/0280986 A1
(43) Pub. Date: Sep. 11, 2025

(54) Automatic Food Cooking Device

(71) Applicant: Lohas Fast Food Co., Ltd., Taipei City (TW)

(72) Inventor: Tzuu-Shin Guh, New Taipei City (TW)

(21) Appl. No.: 19/013,278

(22) Filed: Jan. 8, 2025

(30) Foreign Application Priority Data
Mar. 7, 2024 (TW) 113108458

(51) Int. Cl. A47J 27/04; A47J 36/32

(52) U.S. Cl. CPC A47J 27/04; A47J 36/32; A47J 2027/043

(57) ABSTRACT

An automatic food cooking device for cooking an instant frozen meal is provided. The automatic food cooking device includes a device body, a boiler, a first heater, a second heater and a cooking module. The device body has a supporting platform for placing an instant frozen meal. The boiler stores and preheats a cooking liquid from a cooking liquid supply unit. The first heater stores the cooking liquid from the boiler, and heats the cooking liquid to a boiling state to generate a high-temperature cooking liquid. The second heater stores the cooking liquid from the boiler, and heats the cooking liquid to a steam state to generate a cooking steam. The cooking module inputs high-temperature cooking liquid and cooking steam into quick-cooking frozen food in a predetermined ratio.

### CROSS-REFERENCE TO RELATED APPLICATION(S)

This application claims priority to Taiwan Patent Application No. 113108458 filed on Mar. 7, 2024, and all the benefits accruing therefrom under 35 U.S.C. § 119, the content of which in its entirety is herein incorporated by reference.

### BACKGROUND OF THE INVENTION

### 1. Field of the Invention

The present invention relates to a kitchen cooking device, and more particularly to an automatic food cooking device utilizing a steaming method.

### 2. Description of the Related Art

Existing automatic cooking devices, such as air fryers and stir-fryers, usually require users to prepare ingredients and seasonings by themselves, and place the ingredients and the seasonings at specific locations before cooking. Therefore, the process of preparing ingredients and seasonings independently has led to issues such as inconvenience in preparation and long cooking times, resulting in a poor user experience.

As a result, instant frozen meals are available on the market, in which the ingredients are pre-cooked and then frozen, allowing to be readily served with simple preparation in a short time. Among these methods, users can heat the food by pouring hot water or using a water bath before consumption; however, such the method still presents many inconveniences for the users. Another method involves using a steaming tool, which can automatically heat the instant frozen meal after the user places the instant frozen meal in position within the steaming tool; however, steaming tools often have issues such as large size and complex structure.

### SUMMARY OF THE INVENTION

The purpose of the present invention is to provide an automatic food cooking device to address the above-mentioned issues.

Based on the above objectives, the present invention provides an automatic food cooking device, which includes a device body, a boiler, a first heater, a second heater and a cooking module. The device body has a supporting platform; and the instant frozen meal is placed on the supporting platform. The boiler is disposed in the device body, and the boiler is connected to a cooking liquid supply unit; the boiler is configured to store and preheat a cooking liquid from the cooking liquid supply unit. The first heater is disposed in the device body, and the first heater is connected to the boiler; the first heater is configured to store and heat the cooking liquid from the boiler, so as to generate a high-temperature cooking liquid. The second heater is disposed in the device body, and the second heater is connected to the boiler; the second heater is configured to store the cooking liquid from the boiler, and heat the cooking liquid to a steam state to generate a cooking steam. The cooking module is disposed in the device body and corresponding to the supporting platform, and one end of the cooking module is exposed to the outside the device body and is configured to be displaced relative to the instant frozen meal. The cooking module is connected to the first heater and the second heater to receive the high-temperature cooking liquid and the cooking steam, and input the high-temperature cooking liquid and the cooking steam into the instant frozen meal in a predetermined ratio.

Preferably, the cooking module may include a cooking component. The cooking component may have an inner tube, an outer tube and a piercing head. The inner tube may be disposed in the outer tube; one end of the inner tube may be connected to the first heater. One end of the outer tube may be connected to the second heater. The piercing head may be arranged at another end of the outer tube, the inner tube may be connected to a first channel of the piercing head, and the outer tube may be connected to a second channel of the piercing head.

Preferably, the cooking module may include a supporting tube, and the supporting tube may be sleeved onto the cooking component. A leak-proof member may be provided at one end of the supporting tube adjacent to the piercing head, and the leak-proof member may have a shape of a suction cup.

Preferably, the cooking module may include two telescopic positioning members, and each of two sides of the supporting tube may be provided with a plurality of positioning portions. The two telescopic positioning members may be arranged oppositely on the two sides of the supporting tube, and the two telescopic positioning members may be selectively embedded in or detached from one of the positioning portions.

Preferably, a fixed portion may be provided on a top of the device body, and the cooking liquid supply unit may be a canister storing cooking liquid and arranged on the fixed portion.

Preferably, the cooking liquid supply unit may be an indoor water supply pipe.

Preferably, the cooking module may include a driving module, and the driving module may include a driving frame, a driving unit, a transmission rod, a plurality of guide rods and a supporting plate. The driving unit and the plurality of guide rods may be arranged on the driving frame, the transmission rod may be connected to the driving unit, the supporting plate may be configured to fix the cooking component, be screwed on the transmission rod, and allow the plurality of guide rods to slide through.

Preferably, a liquid storage unit may be provided on a lower side of the supporting platform, and the liquid storage unit may be connected to the second heater.

Preferably, the automatic food cooking device may include a processor. The supporting platform may be provided with a reader, and the reader may be connected to the processor and configured to read an identifier of the instant frozen meal. The processor may be configured to control the cooking module to input the high-temperature cooking liquid and the cooking steam into the instant frozen meal in the predetermined ratio corresponding to a signal acquired from the identifier.

Preferably, the processor may be configured to control the cooking module to cook the instant frozen meal according to a cooking time corresponding to the signal acquired from the identifier.

Preferably, the cooking module may include a temperature sensing unit disposed in the cooking module, and the processor may further be configured to adjust the predetermined ratio and the cooking time according to a signal of the temperature sensing unit.

Preferably, a first flow regulator may be provided between the first heater and the boiler or between the second heater and the boiler, and the first flow regulator may be electrically connected to the processor.

Preferably, a second flow regulator may be provided between the second heater and the boiler or between the first heater and the boiler, and the second flow regulator may be electrically connected to the processor.

The technical features of the present invention will be described in detail below with specific embodiments and accompanying drawings so that a person skilled in the art can easily understand the purpose, technical features, and advantages of the present invention.

### BRIEF DESCRIPTION OF THE DRAWINGS

In order to more clearly illustrate the technical solutions of the embodiments of the present invention, the drawings required for use in the description of the embodiments of the present invention will be briefly introduced below. Obviously, the drawings described below are only some embodiments of the present invention. For those with ordinary knowledge in the technical field to which the present invention belongs, other drawings can be obtained based on these drawings.

FIG. 1 is a first structural schematic diagram of an automatic food cooking device of the present invention.

FIG. 2 is a second structural schematic diagram of the automatic food cooking device of the present invention.

FIG. 3 is a third structural schematic diagram of the automatic food cooking device of the present invention.

FIG. 4 is a fourth structural schematic diagram of the automatic food cooking device of the present invention.

FIG. 5 is a schematic structural diagram of a cooking module of the automatic food cooking device of the present invention.

FIG. 6 is a schematic structural diagram of a cooking component of the automatic food cooking device of the present invention.

FIG. 7 is a schematic structural diagram of a driving module of the automatic food cooking device of the present invention.

FIG. 8 is a block diagram of the automatic food cooking device of the present invention.

FIG. 9 is a schematic diagram of quick cooking frozen food for the automatic food cooking device of the present invention.

### DETAILED DESCRIPTION OF THE PREFERRED EMBODIMENTS

The advantages, features and technical methods achieved by the present invention will be described in more detail with reference to exemplary embodiments and the attached drawings so as to be easier to understand, and the present invention can be implemented in different forms, so it should not be understood to be limited to the embodiments described herein. On the contrary, for those with ordinary knowledge in the relevant technical field, the provided embodiments will make the present disclosure more thorough and comprehensive and completely convey the scope of the present invention, and the present invention will only be defined by the scope of the attached patent application.

It should be understood that although the terms “first”, “second”, and the like may be used in the present invention to describe various elements, components, regions, sections, layers and/or parts, these elements, components, regions, sections, layers and/or parts should not be limited by these terms. These terms are only used to distinguish one element, component, region, section, layer and/or section from another element, component, region, section, layer and/or section.

Unless otherwise defined, all terms (including technical and scientific terms) used in the present invention have the same meaning as commonly understood by one of ordinary skill in the art to which the present invention belongs. It will be further understood that those terms as defined in commonly used dictionaries should be interpreted as having definitions that are consistent with their meanings in the context of the relevant art and the present invention, and will not be interpreted as idealized or overly formal meanings unless expressly so defined herein.

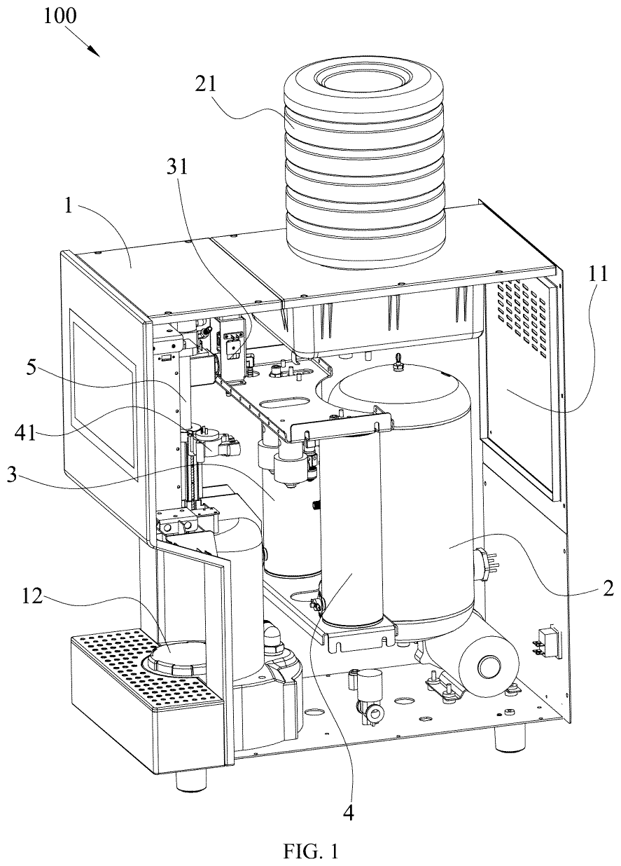

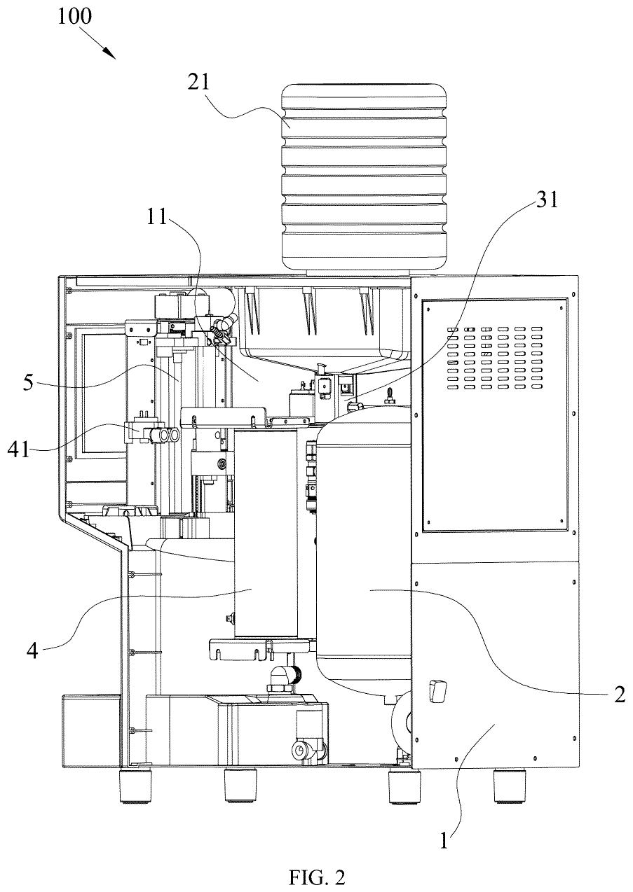

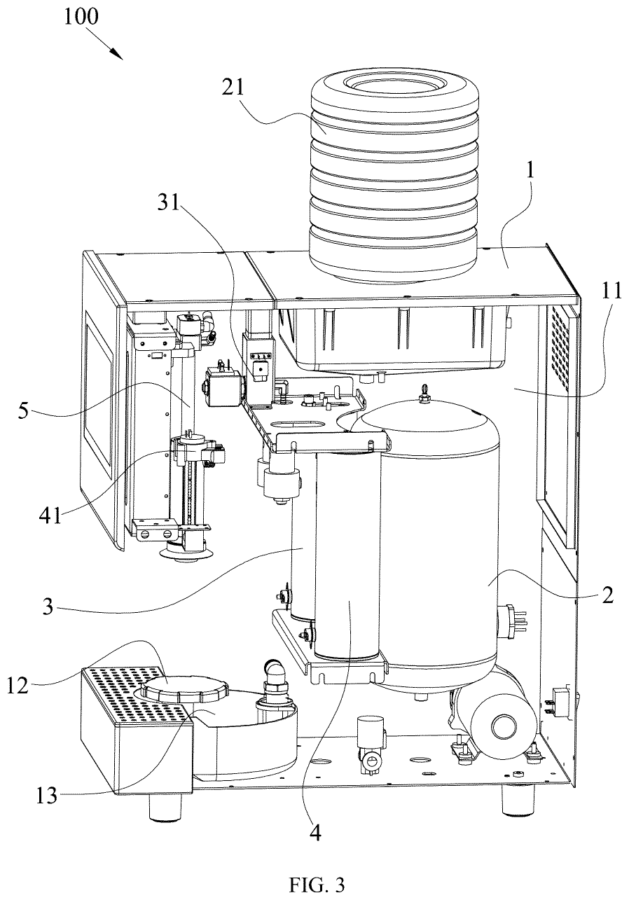

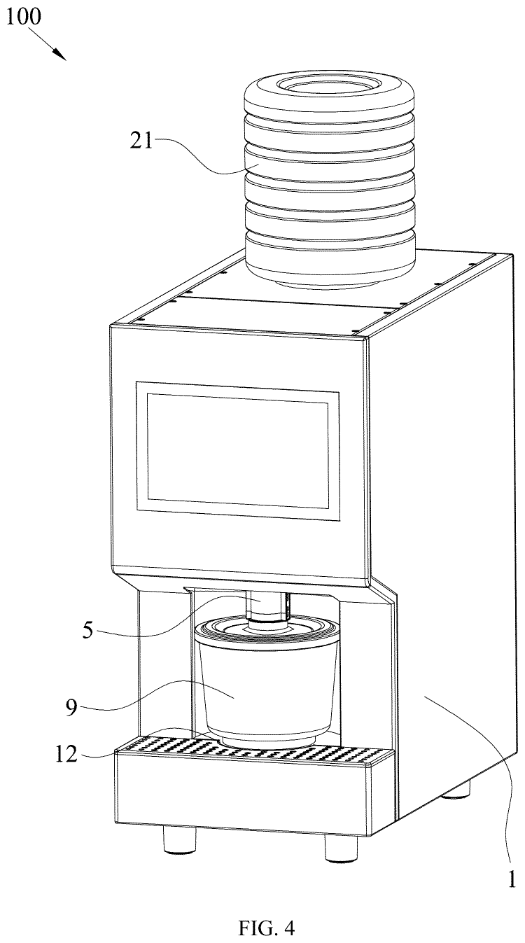

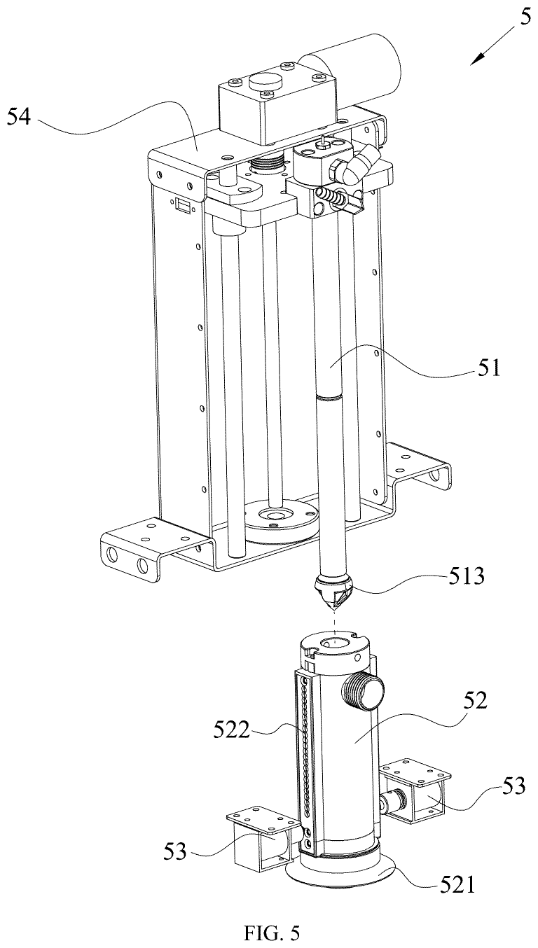

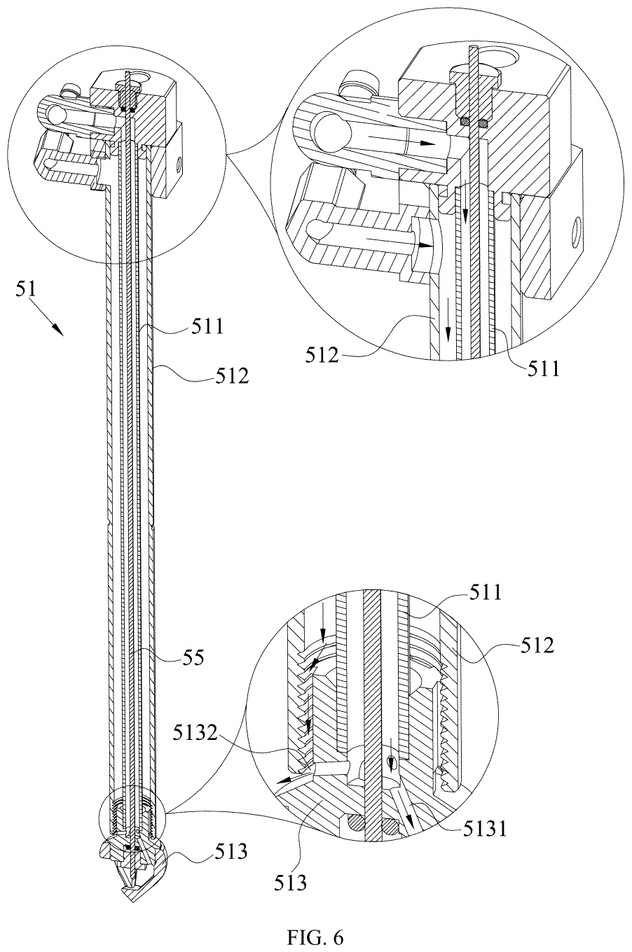

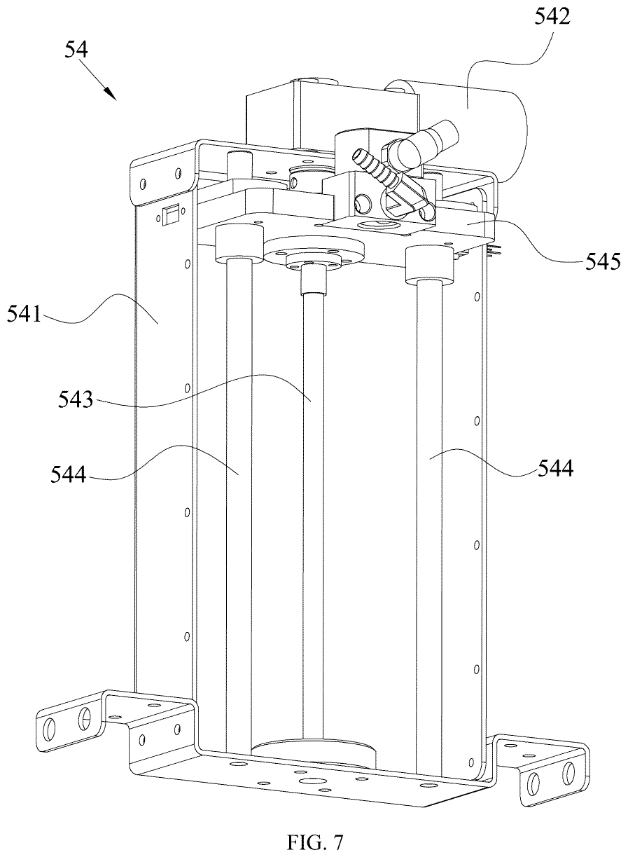

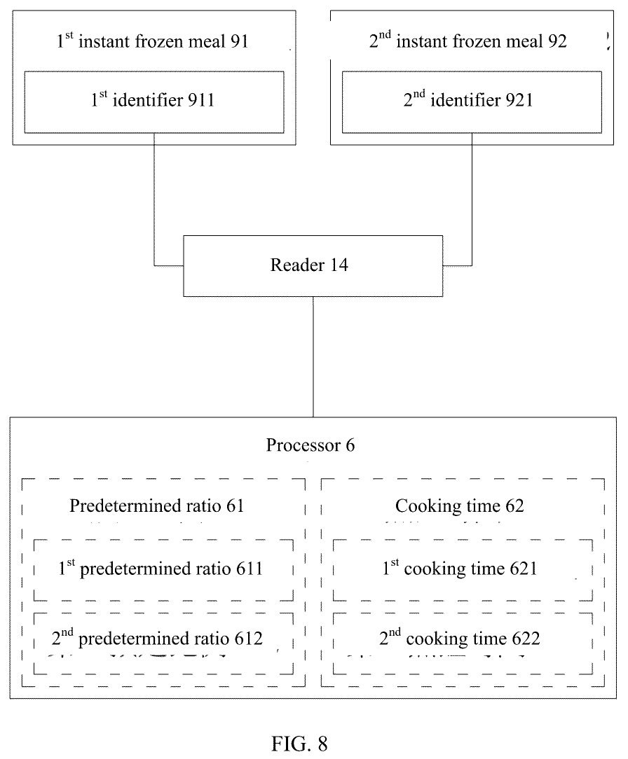

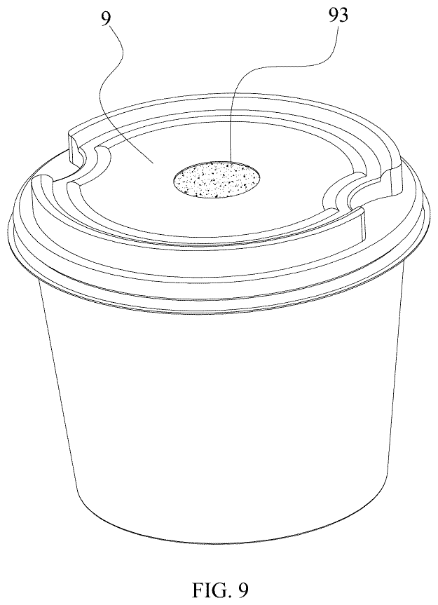

Reference is made to FIGS. 1 to 9. FIGS. 1 to 3 are schematic diagrams showing certain housing components of the automatic food cooking device of the present invention. FIG. 4 is a schematic diagram showing the overall appearance of the automatic food cooking device of the present invention and quick-cooking frozen food being placed. FIGS. 5 to 7 are schematic diagrams of the cooking module of the automatic food cooking device of the present invention. FIG. 8 is a block diagram of the automatic food cooking device of the present invention. FIG. 9 is a schematic diagram of the instant frozen meal for the automatic food cooking device of the present invention.

As shown in FIGS. 1 to 9, the automatic food cooking device 100 of the present invention is applied to cook an instant frozen meal 9. The automatic food cooking device 100 mainly includes a device body 1, a boiler 2, a first heater 3, a second heater 4 and a cooking module 5. The instant frozen meal 9 may be prepared by cooking ingredients in advanced and then freezing and packaging the cooked ingredients into a box-shaped or bowl-shaped product; as shown in FIG. 9. Preferably, the instant frozen meal 9 may have a bowl-shaped structure, and a top of the instant frozen meal 9 may have a piercing portion 93 for the cooking module 5 to be inserted or extended therein for heating.

The device body 1 may be formed by a plastic housing or a combination of a plastic housing and a metal sheet. In this embodiment, the device body 1 may have a receiving space 11 for receiving required components. A front side of the device body 1 may be equipped with a support platform 12. The instant frozen meal 9 may be placed on the supporting platform 12. In various embodiments, the support platform 12 may also be disposed on a left side or a right side of the device body 1, and the support platform 12 may be configured according to actual needs. The present invention is not limited thereto.

The boiler 2 may be a boiler that is known to or commonly used by those skilled in the art, and the boiler 2 may be disposed in the receiving space 11. Preferably, the boiler 2 may be disposed adjacent to a rear side of the device body 1. The boiler 2 may be connected to a cooking liquid supply unit 21. In this way, the boiler 2 is configured to store and preheat the cooking liquid from the cooking liquid supply unit 21. The preheating may be, for example, first boiling the cooking liquid and then maintaining the boiled cooking liquid at a predetermined temperature, such as 80° C., 85° C. or 90° C., or directly heating the cooking liquid to a predetermined temperature and maintaining the cooking liquid at the predetermined temperature, and the present invention is not limited thereto.

It is worth mentioning that the cooking liquid may be, for example, drinking water or indoor tap water. That is, the cooking liquid supply unit 21 may be an indoor water supply pipe, for example, the boiler 2 may be connected to a faucet in the indoor space via the pipeline. Preferably, a fixed portion 13 may be provided on the top of the device body 1, and the cooking liquid supply unit 21 may be a canister storing the cooking liquid. The cooking liquid supply unit 21 may be arranged on the fixed portion and connected to the boiler 2 through a pipeline. It is worth mentioning that, in the relevant drawings of the present invention, in order to avoid the drawings being too complicated and thus hindering the understanding of the features of the present invention, pipes connected between components are omitted. In addition, the boiler 2 may include drainage-related components, heating-related components such as heating rods, and a temperature sensing unit used for temperature monitoring.

The first heater 3 may be a boiler that is known to or commonly used by those skilled in the art, and a capacity of the first heater 3 may be smaller than that of the boiler 2. The first heater 3 may be disposed in the receiving space 11. Preferably, the first heater 3 may be located at the front side of the boiler 2. The first heater 3 may be connected to the boiler 2 via a pipeline.

The first heater 3 may be configured to store the cooking liquid from the boiler 2 and heat the cooking liquid to generate a high-temperature cooking liquid. For the high-temperature cooking liquid, for example, when the boiler 2 first boils the cooking liquid and then maintains the boiled cooking liquid at the predetermined temperature, the high-temperature cooking liquid may have a temperature (e.g., 95° C.) higher than the predetermined temperature. Alternatively, when the boiler 2 directly heats the cooking liquid to the predetermined temperature and maintained at the predetermined temperature. The high-temperature cooking liquid may be generated from first boiling the cooking liquid and then the boiled cooking liquid may be maintained at a temperature that is higher than the predetermined temperature. In addition, the first heater 3 may include drainage-related components, heating-related components such as heating rods, and a temperature sensing unit used for temperature monitoring.

The second heater 4 may be a boiler that is known to or commonly used by those skilled in the art, and a capacity of the second heater 4 may be smaller than that of the boiler 2 and the same as that of the first heater 3. The second heater 4 may be disposed in the receiving space 11. Preferably, the second heater 4 may be located in front of the boiler 2 and spaced apart and arranged side by side with the first heater 3. The second heater 4 may be connected to the boiler 2 via a pipeline. The second heater 4 may store the cooking liquid from the boiler 2 and heat the cooking liquid to a steam state to generate a cooking steam. In addition, the second heater 4 may include drainage-related components, heating-related components such as heating rods, and a temperature sensing unit used for temperature monitoring.

Reference is made to FIGS. 5 to 7. The cooking module 5 may include a cooking component 51, a supporting tube 52, two telescopic positioning members 53 and a driving module 54. The cooking module 5 may be disposed in the receiving space 11 corresponding to the supporting platform 12, and one end of the cooking module may be exposed to the outside of the device body 1, and configured to be displaced relative to the instant frozen meal 9. The cooking module 5 may be connected to the first heater 3 and the second heater 4 to receive the high-temperature cooking liquid and the cooking steam, and input the high-temperature cooking liquid and the cooking steam into the instant frozen meal in a predetermined ratio 61. The predetermined ratio 61 will be explained hereinafter.

Specifically, the cooking component 51 may have an inner tube 511, an outer tube 512 and a piercing head 513. The inner tube 511 and the outer tube 512 may be made of high-temperature resistant plastic materials or rubber materials, or may be made of metal materials. Alternatively, the outer tube 512 may be made of metal material and coated with a protective layer that can block heat transfer on its outer surface. The inner tube 511 may be disposed in the outer tube 512, thereby forming an inner tube flow channel and an outer tube flow channel between the outer tube 512 and the inner tube 511. One end of the inner tube 511 may be connected to the first heater 3 via a pipeline, and one end of the outer tube 512 may be connected to the second heater 4 via a pipeline. The way in which the inner tube 511 is connected to the first heater 3 and the outer tube 512 is connected to the second heater 4 may be achieved by using a pipeline joint (such as a VCR joint). The piercing head 513 may be disposed at another end of the outer tube 512, and the piercing head may be connected to the outer tube 512 and the inner tube 511. The inner tube 511 may be connected to a first channel 5131 of the piercing head 513, and the outer tube 512 may be connected to a second channel 5132 of the piercing head 513.

In this way, when the cooking component 51 is driven such that the piercing head 513 is inserted or extended into the instant frozen meal 9 through the piercing portion 93, the cooking element 51 would use the first channel 5131 to output the high-temperature cooking liquid and use the second channel 5132 to output the cooking steam into the instant frozen meal 9, so as to heat the food contained in the instant frozen meal 9. Preferably, the piercing portion 93 may be provided with a film or a sealing film to preserve or prevent the food contained therein from leaking out, and the piercing head 513 may be inserted into or extended into the instant frozen meal 9 by piercing or breaking the film or the sealing film.

It should be particularly noted that, although implementation aspects of the first channel 5131 outputting the high-temperature cooking liquid and the second channel 5132 outputting the cooking steam are mentioned above, the aspects may be changed as needed in actual use. For example, the inner tube 511 may be connected to the second heater 4, and the outer tube 512 may be connected to the first heater 3. Therefore, the present invention should not be limited to the exemplary implementation aspects.

The supporting tube 52 may be made of high temperature resistant plastic material or rubber material, or may be made of metal material. The supporting tube 52 may be sleeved onto the cooking component 51 and fixed to the cooking component 51, so as to move along with the displacement of the cooking component 51.

It is worth mentioning that each of both sides of the supporting tube 52 may be provided with a plurality of positioning portions 522, and the two telescopic positioning members 53 may be arranged oppositely on both sides of the supporting tube 52, and the two telescopic positioning members 53 may be selectively embedded in or separated from one of the positioning portions 522. For example, the plurality of positioning portions 522 may be a plurality of circular holes arranged at intervals, and each of the telescopic positioning members 53 may be a pneumatic canister or a hydraulic canister. Thereby, when the cooking component 51 and the supporting tube 52 are displaced to a positioning point, a telescopic end of the telescopic positioning member 53 may be inserted or embedded into the circular hole of the positioning portion 522, thereby preventing the cooking component 51 from being unexpectedly displaced during the process of heating the food contained in the instant frozen meal 9. It is also worth mentioning that a leakage-proof member 521 may be provided at one end of the supporting tube 52 adjacent to the piercing head 513, and the leakage-proof member 521 may have a shape of a suction cup. For example, when the cooking component 51 and the supporting tube 52 are displaced, the leak-proof member 521 would first be attached to a top surface of the instant frozen meal 9, and then the piercing head 513 may be extended from the leak-proof member 521 and inserted or extended into the instant frozen meal 9. In this way, when the cooking component 51 and the supporting tube 52 are displaced to the positioning point, the piercing head 513 may be extended from the leak-proof member 521 and inserted or extended into the instant frozen meal 9. To this extent, the leak-proof element 521 may be attached to the top surface of the instant frozen meal 9, thereby preventing the cooking steam or high-temperature cooking liquid from overflowing.

The driving module 54 may driving frame 541, a driving unit 542, a transmission rod 543, a plurality of guide rods 544 and a supporting plate 545. The driving frame 541 may be a frame made of plastic material, metal material, or a frame formed by combining certain components made of plastic material and certain components made of gold material. The driving frame 541 generally may include two plates spaced apart from each other, and a peripheral wall or a connecting rod may be disposed between the two plates. The driving unit 542 and the plurality of guide rods 544 may be disposed on the driving frame 541; the driving unit 542 may be a motor, which may be disposed on the outer side between the two plates, and the plurality of guide rods 544 may be disposed between the two plates. The driving rod 543 may be located between the two plates, one end of the driving rod 543 may be connected to the driving unit 542, and another end of the driving rod 543 may be rotatably disposed on the plate relative to the driving unit 542, so as to be driven and rotated by the driving unit 542. The supporting plate 545 may be used to fix the cooking component 51, and may be screwed on the driving rod 543, and allow the plurality of guide rods 544 to slide through.

In this way, when the drive unit 542 drives the transmission rod 543 to rotate, it may cause the supporting plate 545 to produce linear displacement, thereby allowing the cooking component 51 to move closer to or away from the instant frozen meal 9. Furthermore, when the cooking element 51 is displaced to a certain position, the telescopic end of the telescopic positioning member 53 may be inserted or embedded into the circular hole of the positioning portion 522, thereby preventing the cooking component 51 from unexpectedly displacing, and increasing the stability of the cooking element 51 when injecting the cooking steam and the high-temperature cooking liquid.

Reference is made to FIG. 8. The instant frozen meal 9 used by the automatic food cooking device 100 of the present invention generally refers to a variety of instant frozen meals, such as soy sauce ramen, salt ramen, pork bone ramen or miso ramen, or the like; or chicken drumstick rice, pork ribs rice, barbecued pork rice or beef (pork) meat rice, or the like; with large bowl capacity, medium bowl capacity or small bowl capacity. Different types of the instant frozen meals 9 require different ratios of the cooking steam and the high-temperature cooking liquid, and the heating time also varies.

For example, the instant frozen meal 9 may include a first instant frozen meal 91 and a second instant frozen meal 92. The first instant frozen meal 91 may be, for example, a pork bone ramen, and the second instant frozen meal 92 may be, for example, a miso ramen. Since the first instant frozen meal 91 and the second instant frozen meal 92 are different, the ratios of the cooking steam to the high-temperature cooking liquid are different and the heating times therefore are also different; therefore, the processor 6 of the automatic food cooking device 100 correspondingly stores a first predetermined ratio 611 and a first cooking time 621 corresponding to the first instant frozen meal 91, and a second predetermined ratio 612 and a second cooking time 622 corresponding to the second instant frozen meal 92.

On the other hand, the instant frozen meal 9 may have an identifier. For example, the first instant frozen meal 91 and the second instant frozen meal 92 may have a first identifier 911 and a second identifier 921, respectively. The supporting platform 12 may be provided with a reader 14, which may be configured to read the first identifier 911 or the second identifier 921. For example, the identifier may be arranged at the bottom of the instant frozen meal 9, and the reader 14 may be arranged on a surface of the supporting platform 12. In this way, when the instant frozen meal 9 is placed on the supporting platform 12, the reader 14 may read the identifier accordingly.

Therefore, the processor 6 may be configured to control the cooking module 5 according to a signal of the first identifier 911 or the second identifier 921 to heat the instant frozen meal 9 according to the predetermined ratio 61 and the cooking time 62 corresponding to the signal acquired from the first identifier 911 and the second identifier 921.

For example, when the first instant frozen meal 91 is placed on the supporting platform 12, the processor 6 may be configured to, in response to receiving the signal of the first identifier 911, inject the cooking steam and the high-temperature cooking liquid into the first instant frozen meal 91 according to the first predetermined ratio 611 for the first cooking time 621. For another example, when the first instant frozen meal 91 is provided with a large bowl capacity, the processor 6 may be configured to control the driving module 54 in response to receiving the signal acquired from the first identifier 911, such that the cooking component 51 may be displaced to a height corresponding to the first instant frozen meal 91, and then, the cooking steam and the high-temperature cooking liquid may be injected into the first instant frozen meal 91 according to the first predetermined ratio 611 for the first cooking time 621. When the second instant frozen meal 92 is provided in a small bowl capacity, the processor 6 may be configured to control the driving module 54 in response to receiving the signal acquired from the second identifier 921, such that the cooking component 51 may be displaced to a height corresponding to the second instant frozen meal 92. The rest may be similar to the first instant frozen meal 91, and will not be described in detail here.

It is worth mentioning that the cooking module 5 may include a temperature sensing unit 55 disposed in the cooking module 5, and the processor 6 may be further configured to adjust the predetermined ratio 61 and the cooking time 62 according to the signal of the temperature sensing unit 55.

In addition, a first flow regulator 31 may be disposed between the first heater 3 and the boiler 2 or between the second heater 4 and the boiler 2, and may be electrically connected to the processor 6. A second flow regulator 41 may be disposed between the second heater 4 and the boiler 2 or between the first heater 3 and the boiler 2, and may be electrically connected to the processor 6. For example, the first flow regulator 31 may be disposed between the first heater 3 and the boiler 2, and the second flow regulator 41 may be disposed between the second heater 4 and the boiler 2. The processor 6 may be configured to control the first flow regulator 31 and the second flow regulator 41 to inject the cooking steam and the high-temperature cooking liquid into the instant frozen meal 9 according to a predetermined ratio 61.

In summary, the automatic food cooking device of the present invention may have a compact size, may be easy to operate, and may heat instant frozen meals safely and quickly.

Through the description of the above implementation methods, a person with ordinary knowledge in the relevant technical field may clearly understand that each implementation method may be implemented by software plus a necessary general hardware platform, and of course may also be implemented by hardware. Based on this understanding, the above technical solution in essence or the part that contributes to the knowledge and technology may be embodied in the form of a software product, which may be stored in a computer-readable storage medium, such as ROM/RAM, a disk, an optical disk, etc., and may include a number of instructions for enabling a computer device (which may be a personal computer, a server, or a network device, etc.) to execute the methods described in each embodiment or some parts of the embodiments.

The above description is for illustrative purposes only and is not intended to be limiting. Any equivalent modifications or changes made to the present invention without departing from the spirit and scope of the present invention shall be included in the scope of the attached patent application.

What is claimed is:

1. An automatic food cooking device, comprising:
a device body having a supporting platform for placing an instant frozen meal;
a boiler disposed in the device body, wherein the boiler is connected to a cooking liquid supply unit, and the boiler is configured to store and preheat a cooking liquid from the cooking liquid supply unit;
a first heater disposed in the device body, wherein the first heater is connected to the boiler, and the first heater is configured to store and heat the cooking liquid from the boiler, so as to generate a high-temperature cooking liquid;
a second heater disposed in the device body, wherein the second heater is connected to the boiler, and the second heater is configured to store the cooking liquid from the boiler, and heat the cooking liquid to a steam state to generate a cooking steam; and
a cooking module disposed in the device body and corresponding to the supporting platform, wherein one end of the cooking module is exposed outside the device body and is configured to be displaced relative to the instant frozen meal, the cooking module is connected to the first heater and the second heater to receive the high-temperature cooking liquid and the cooking steam, and input the high-temperature cooking liquid and the cooking steam into the instant frozen meal in a predetermined ratio.

2. The automatic food cooking device according to claim 1, wherein the cooking module includes a cooking component having an inner tube, an outer tube and a piercing head, the inner tube is disposed in the outer tube, one end of the inner tube is connected to the first heater, one end of the outer tube is connected to the second heater, the piercing head is arranged at another end of the outer tube, the inner tube is connected to a first channel of the piercing head, and the outer tube is connected to a second channel of the piercing head.

3. The automatic food cooking device according to claim 2, wherein the cooking module includes a supporting tube, the supporting tube is sleeved onto the cooking component, and a leak-proof member is provided at one end of the supporting tube adjacent to the piercing head, and the leak-proof member has a shape of a suction cup.

4. The automatic food cooking device according to claim 3, wherein the cooking module includes two telescopic positioning members, each of two sides of the supporting tube is provided with a plurality of positioning portions, the two telescopic positioning members are arranged oppositely on the two sides of the supporting tube, and the two telescopic positioning members are configured to be selectively embedded in or detached from one of the positioning portions.

5. The automatic food cooking device according to claim 4, wherein a fixed portion is provided on a top of the device body, and the cooking liquid supply unit is a canister storing cooking liquid and arranged on the fixed portion.

6. The automatic food cooking device according to claim 4, wherein the cooking liquid supply unit is an indoor water supply pipe.

7. The automatic food cooking device according to claim 2, wherein the cooking module includes a driving module, the driving module includes a driving frame, a driving unit, a transmission rod, a plurality of guide rods and a supporting plate, the driving unit and the plurality of guide rods are arranged on the driving frame, the transmission rod is connected to the driving unit, the supporting plate fixes the cooking component, is screwed on the transmission rod, and allows the plurality of guide rods to slide through.

8. The automatic food cooking device according to claim 1, wherein a liquid storage unit is provided on a lower side of the supporting platform, and the liquid storage unit is connected to the second heater.

9. The automatic food cooking device according to claim 1, further comprising a processor, wherein the supporting platform is provided with a reader, the reader is connected to the processor and configured to read an identifier of the instant frozen meal, the processor is configured to control the cooking module to input the high-temperature cooking liquid and the cooking steam into the instant frozen meal in the predetermined ratio corresponding to a signal acquired from the identifier.

10. The automatic food cooking device according to claim 9, wherein the processor is configured to control the cooking module to cook the instant frozen meal according to a cooking time corresponding to the signal acquired from the identifier.

11. The automatic food cooking device according to claim 10, wherein the cooking module includes a temperature sensing unit disposed in the cooking module, and the processor is further configured to adjust the predetermined ratio and the cooking time according to a signal of the temperature sensing unit.

12. The automatic food cooking device according to claim 11, wherein a first flow regulator is provided between the first heater and the boiler or between the second heater and the boiler, and the first flow regulator is electrically connected to the processor.

13. The automatic food cooking device according to claim 12, wherein a second flow regulator is provided between the second heater and the boiler or between the first heater and the boiler, and the second flow regulator is electrically connected to the processor.
